(19) United States
(12) Patent Application Publication
(10) Pub. No.: US 2026/0196681 A1
(43) Pub. Date: Jul. 9, 2026

(54) PIN ASSEMBLY AND BATTERY CELL INCLUDING SAME

(71) Applicant: SK On Co., Ltd., Seoul (KR)

(72) Inventors: Byeong Jun PAK, Daejeon (KR); Seung Ho KWAK, Daejeon (KR); Hoemin CHEONG, Daejeon (KR)

(21) Appl. No.: 19/441,869

(22) Filed: Jan. 7, 2026

(30) Foreign Application Priority Data
Jan. 9, 2025 (KR) 10-2025-0003445
Sep. 23, 2025 (KR) 10-2025-0136946

(51) Int. Cl. H01M 50/533; H01M 50/176; H01M 50/528; H01M 50/567

(52) U.S. Cl. CPC H01M 50/533; H01M 50/176; H01M 50/528; H01M 50/567

(57) ABSTRACT

A pin assembly is provided. The pin assembly includes a pin portion electrically connected to an electrode terminal portion, and a current collector plate portion electrically connected to an electrode assembly. The pin portion and the current collector plate portion form a first inclined portion and are formed as a single member.

### CROSS-REFERENCE TO RELATED APPLICATION(S

This patent document claims the priority and benefits of Korean Patent Application No. 10-2025-0003445 filed on January 9, 2025 and Korean Patent Application No. 10-2025-0136946 filed on September 23, 2025, the disclosures of which are incorporated herein by reference in their entirety.

### TECHNICAL FIELD

The disclosure and implementations disclosed in this patent document generally relate to a pin assembly and a battery cell including the same.

### BACKGROUND

Secondary batteries are a type of energy storage device that may be charged and discharged. Secondary batteries are widely used in various devices that use electricity as a power source. For example, secondary batteries are used as energy storage devices in a variety of devices, from small devices like mobile phones, laptops, and tablets to large devices like cars and aircraft. Recently, secondary batteries have been actively explored as vehicle power sources.

Secondary batteries may be categorized into lead-acid batteries, nickel-cadmium batteries, nickel-metal hydride batteries, lithium-ion batteries, and the like, depending on the electrode material thereof. Each type of secondary battery may be appropriately selected based on design capacity, usage environment, and other factors. Lithium-ion batteries may implement relatively high voltage and capacity, as compared to other types of secondary batteries. Consequently, lithium-ion batteries are widely used in applications requiring high-density energy storage, such as vehicle battery packs.

Secondary batteries, such as lithium-ion batteries, mainly consist of cathode materials, anode materials, separators, and electrolytes as main components thereof. The cathode material and anode material are disposed with an insulating separator therebetween, and charging or discharging may occur by the movement of ions through the electrolyte.

### SUMMARY

The present disclosure can be implemented in some embodiments to provide an improved pin assembly and a battery cell including the same.

The battery cell in the present disclosure may be widely applied to electric vehicles, battery charging stations, and other green technology fields such as solar power generation and wind power generation utilizing batteries.

Furthermore, the battery cell in the present disclosure may be used in eco-friendly electric vehicles, hybrid vehicles, and other vehicles that ameliorate the effects of climate change by suppressing air pollution and greenhouse gas emissions.

In some embodiments, a pin assembly includes a pin portion electrically connected to an electrode terminal portion, and a current collector plate portion electrically connected to an electrode assembly. The pin portion and the current collector plate portion form a first inclined portion and are formed as a single member.

In an embodiment, the pin portion and the current collector plate portion may be formed by a forging process.

In an embodiment, a first cross section formed by a connection portion between the first inclined portion and the pin portion may have a smaller area than an area of a second cross-section formed by a connection portion between the first inclined portion and the current collector plate portion.

In an embodiment, an outer circumferential surface of the first inclined portion may form a curved surface along with and may be connected to an outer circumferential surface of the pin portion and the current collector plate portion.

In an embodiment, the pin portion may include a protruding body portion having one end connected to the current collector plate portion while forming the first inclined portion with the current collector plate portion, and a top portion disposed at the other protruding end of the body portion, and the body portion and the top portion may be connected to form a second inclined portion.

In an embodiment, a third cross-section formed by a connection portion between the second inclined portion and the pin portion may have a larger area than an area of a fourth cross-section formed by a connection portion between the second inclined portion and the top portion.

In some embodiments, a battery cell includes an electrode assembly, a case forming a receiving portion for accommodating the electrode assembly, s cap assembly coupled to the case and having an electrode terminal portion disposed thereon, and a pin assembly electrically connecting the electrode assembly and the electrode terminal portion. The pin assembly includes a pin portion electrically connected to the electrode terminal portion, and a current collector plate portion electrically connected to the electrode assembly. The pin portion and the current collector plate portion form a first inclined portion and are formed as a single member.

In an embodiment, the pin portion may further includes a body portion which protrudes and one end of which is connected to the current collector plate portion to form the first inclined portion, and an top portion disposed at the protruding other end of the body portion, and the body portion and the top portion may be connected to form a second inclined portion.

In an embodiment, the electrode terminal portion may include a rivet into which the pin portion is inserted, and a terminal unit coupled to the rivet.

In an embodiment, the pin portion may be welded to the rivet and electrically connected to the electrode terminal portion.

In an embodiment, the terminal unit and the rivet may be formed integrally.

### BRIEF DESCRIPTION OF DRAWINGS

Certain aspects, features, and advantages of the present disclosure are illustrated by the following detailed description with reference to the accompanying drawings.

FIG. 1 is a perspective view of a battery cell including a pin assembly according to an embodiment.

FIG. 2 is an exploded perspective view of a battery cell including a pin assembly according to an embodiment.

FIG. 3 is a cross-sectional view taken along line I-I’ of FIG. 1 according to an embodiment.

FIG. 4 is a schematic diagram illustrating an assembly process of part A according to an embodiment.

FIG. 5 is a schematic diagram illustrating an assembly process of part A according to an embodiment.

FIG. 6 is a perspective view of a pin assembly according to an embodiment.

FIG. 7 is a side view of a pin assembly according to an embodiment.

FIG. 8A and 8B are enlarged views of part B of FIG. 7.

### DETAILED DESCRIPTION

Features of the present disclosure disclosed in this patent document are described by example embodiments with reference to the accompanying drawings.

Before proceeding with a detailed description of the present disclosure, it should be noted that the terms and words used in this specification and claims should not be construed as limited to their conventional or dictionary meanings. Based on the principle that inventors may appropriately define the concepts of terms to best describe their inventions, the terms should be interpreted in a way that aligns with the technical spirit of the present disclosure.

Therefore, the embodiments described in this specification and the configurations depicted in the drawings represent only the appropriate example embodiments and do not fully represent the technical spirit of the present disclosure. Therefore, it should be understood that various equivalents and modifications may exist at the time of filing.

Hereinafter, example embodiments will be described in detail with reference to the accompanying drawings. It should be noted that in the attached drawings, identical components are represented by identical symbols as much as possible. Furthermore, detailed descriptions of well-known functions and configurations that may obscure the gist of the present disclosure will be omitted. For the same reason, some components in the accompanying drawings are exaggerated, omitted, or schematically depicted, and the dimensions of respective components do not fully reflect the actual size. For example, in this specification, expressions such as upper side, upper, upward, lower side, lower, downward, side surface, and the like are explained based on the illustration in the drawing, and may be expressed differently if the direction of the object is changed.

Hereinafter, a battery cell 10 according to an embodiment will be described in detail with reference to the drawings.

In the battery cell of the present disclosure, the length direction refers to the direction (X-axis) that crosses the tabs protruding in different directions, the height direction refers to the direction (Y-axis) perpendicular to the length direction from the surface where the tabs are formed, and the thickness direction refers to the direction (Z-axis) perpendicular to the length and height directions.

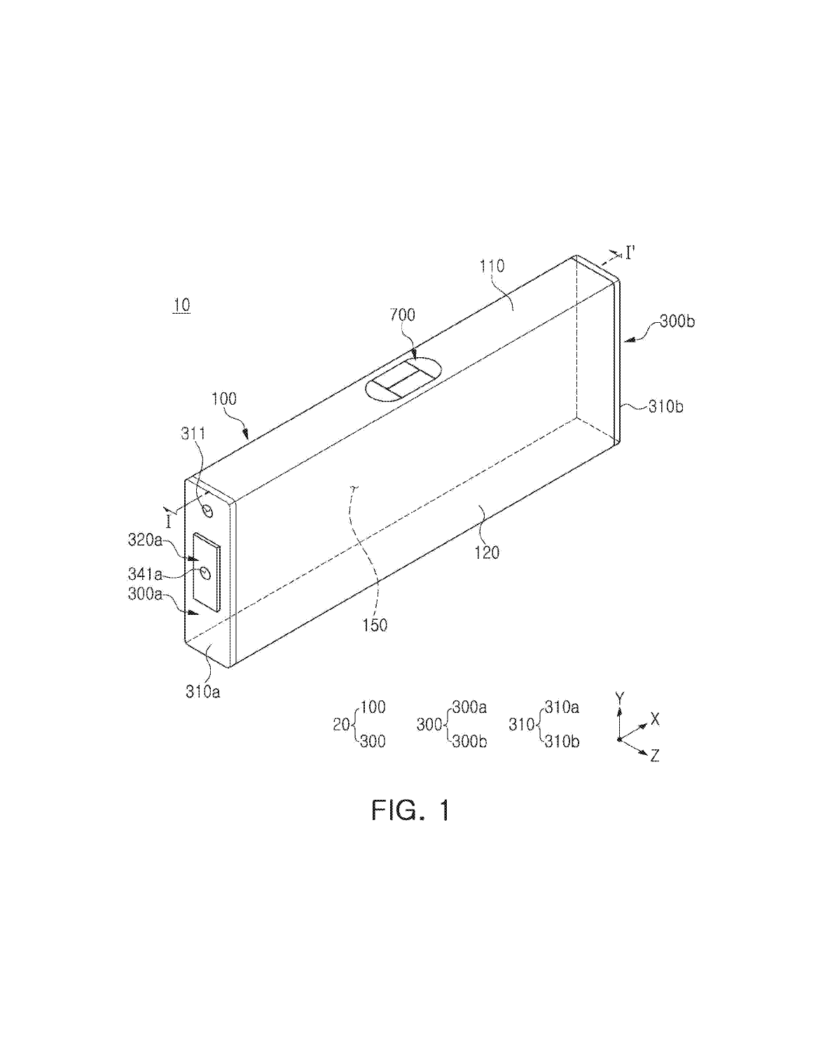

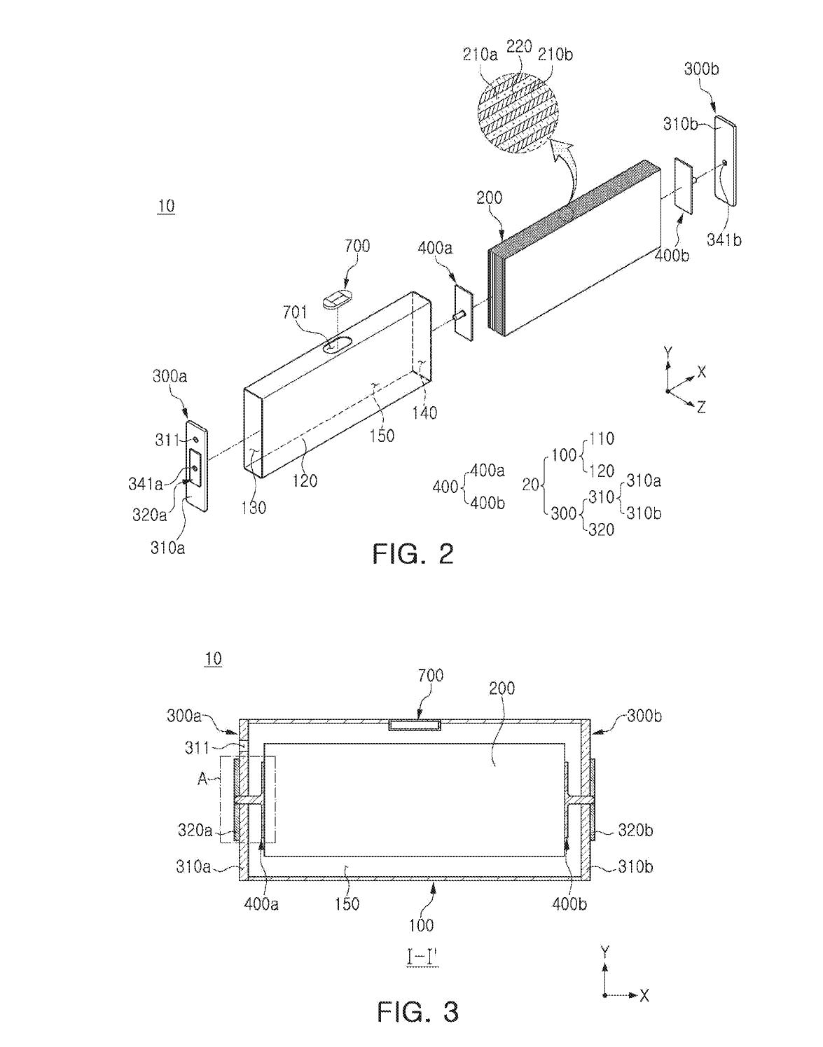

FIG. 1 is a perspective view of a battery cell including a pin assembly according to an embodiment, FIG. 2 is an exploded perspective view of a battery cell including a pin assembly according to an embodiment, and FIG. 3 is a cross-sectional view taken along line I-I’ of FIG. 1 according to an embodiment.

According to an embodiment, a battery cell 10 may include a pin portion 410 electrically connected to an electrode terminal portion 320, and a current collector plate portion 430 electrically connected to an electrode assembly 200. The pin portion 410 and the current collector plate portion 430 form a first inclined portion 421 and may be formed as a single member.

Referring to FIGS. 1 to 3, the battery cell 10 may include a cell housing 20 including a case 100 and a cap assembly 300.

In this case, the cell housing 20 may include a receiving portion 150 accommodating the electrode assembly 200.

The cell housing 20 may include the case 100 having an open structure at both ends, and the cap assembly 300 coupled to both open ends of the case 100.

The case 100 forms at least a portion of the cell housing 20 of the battery cell 10 and may be coupled to the cap assembly 300 to include the receiving portion 150 accommodating the electrode assembly 200.

For example, the case 100 includes the receiving portion 150 and may accommodate the electrode assembly 200 in the receiving portion 150.

In this case, the receiving portion 150 may accommodate the electrolyte together with the electrode assembly 200.

The case 100 may be formed of aluminum and may be referred to as a can or housing.

The case 100 may have a substantially rectangular parallelepiped shape with at least a portion thereof being open.

For example, the case 100 may have a rectangular parallelepiped shape with both ends open, in which a first side surface 110 and a second side surface 120 having a width greater than a width of the first side surface 110 are coupled to each other.

The case 100 may be provided as a hollow hexahedron extending in the length direction (X-axis direction) of the battery cell 10, including the first side surface 110 and the second side surface 120, and with both ends open.

In this case, one of the two open ends of the case 100 may be referred to as a first opening 130, and the other end thereof may be referred to as a second opening 140.

The cell housing 20 may include a pair of cap assemblies 300, and the cap assembly 300 may be respectively provided to be coupled to both ends of the case 100.

In the case of the cap assembly 300, the cap assembly 300 coupled to one end of the case 100 may be referred to as a first cap assembly 300a, and the cap assembly 300 coupled to the other end may be referred to as a second cap assembly 300b.

In detail, the first cap assembly 300a may seal the first opening 130 of the case 100, and the second cap assembly 300b may seal the second opening 140 of the case 100.

Referring to FIG. 3, the electrode assembly 200 may include an electrode plate 210 and a separator 220.

The electrode plate 210 may include a first electrode plate 210a and a second electrode plate 210b having different polarities, and the separator 220 may be an insulator interposed between the first electrode plate 210a and the second electrode plate 210b.

In this case, if the first electrode plate 210a is a cathode plate, the second electrode plate 210b may be an anode plate, and if the first electrode plate 210a is an anode plate, the second electrode plate 210b may be a cathode plate.

The electrode assembly 200 may be configured in which first electrode plates 210a and second electrode plates 210b having different polarities, and separators 220 are repeatedly disposed.

The electrode assembly 200 may be of a winding type, a stacking type, a Z-folding type, or a stack-folding type.

Each electrode plate 210 may have a structure in which an anode active material or a cathode active material is coated on a foil.

For example, the anode plate may be formed by coating graphite or other materials on a copper or nickel foil, and the cathode plate may be formed by coating a transition metal oxide active material on an aluminum foil.

The cap assembly 300 may include a cap plate 310 coupled to the case 100 to seal the case 100, which is open on at least one side.

The cap plate 310 may be formed of aluminum or a material including aluminum. The cap plate 310 may be welded to the case 100 along the edge thereof using ultrasonic welding, laser welding, or other methods.

The cap plate 310 provided in either the first cap assembly 300a or the second cap assembly 300b may include an electrolyte inlet 311 capable of injecting electrolyte into the cell housing 20.

In this case, the electrolyte inlet 311 may be sealed with a stopper or the like after the electrolyte is injected.

In this case, the cap plate 310 coupled to the first cap assembly 300a may be referred to as a first cap plate 310a, and the cap plate coupled to the second cap assembly 300b may be referred to as a second cap plate 310b.

The cap assembly 300 may include an electrode terminal portion 320 provided on the opposite side of the cap plate 310 facing the inside of the case 100.

In this case, the electrode terminal portion 320 may have cathode or anode polarity. The electrode terminal portion 320 may include a first electrode terminal portion 320a and a second electrode terminal portion 320b.

For example, the first electrode terminal portion 320a disposed on the first cap assembly 300a may have an anode polarity, and the second electrode terminal portion 320b disposed on the second cap assembly 300b may have a cathode polarity.

In this case, the electrode terminal portion 320 may be electrically connected to the electrode assembly 200 via a pin assembly 400.

In more detail, the first electrode terminal portion 320a may be electrically connected to the first electrode plate 210a via a first pin assembly 400a, and the second electrode terminal portion 320b may be electrically connected to the second electrode plate 210b via a second pin assembly 400b.

Furthermore, the first electrode terminal portion 320a disposed on the first cap assembly 300a may have cathode polarity, and the second electrode terminal portion 320b disposed on the second cap assembly 300b may have anode polarity.

In this case, the first electrode terminal portion 320a may be electrically connected to the cathode plate, and the second electrode terminal portion 320b may be electrically connected to the anode plate.

A portion of the cell housing 20 may be provided with a vent hole 701 that communicates externally, and the vent hole 701 may be sealed by a venting device 700. In this case, gas within the case 100 may be released through the vent hole 701.

For example, the vent hole 701 may be provided in the first side surface 110 of the case 100.

Referring to FIG. 1, the cell housing 20 may be sealed by coupling the first cap assembly 300a, the second cap assembly 300b, the first side surface 110, and the second side surface 120 to each other.

The vent hole 701 may be provided on at least one of the first side surface 110, the second side surface 120, the first cap assembly 300a, and the second cap assembly 300b, and may connect the interior and exterior of the case 100.

In this case, the vent hole 701 may be formed as a hole, and the shape of the hole may be formed in various ways.

During battery use, gas may be generated inside the battery cell 10 due to external impact, overcharging, or the like, and the generated gas may increase the pressure inside the battery cell 10, thereby degrading the performance of the battery cell 10 or causing damage to the battery cell 10.

Accordingly, gas generated within the battery cell 10 may be removed or discharged to the outside of the battery cell 10 through the vent hole 701.

At least one of the first cap assembly 300a and the second cap assembly 300b may include an electrolyte inlet 311 used to inject electrolyte into the case 100.

For example, the first cap assembly 300a may include an electrolyte inlet 311.

The electrolyte inlet 311 may be provided on the cap plate 310. After the electrolyte is injected, the electrolyte inlet 311 is sealed with a cap or the like to prevent the electrolyte from leaking out of the battery cell 10.

In this case, the electrolyte inlet 311 may be provided in both the first cap assembly 300a and the second cap assembly 300b, or may be provided in only one cap assembly.

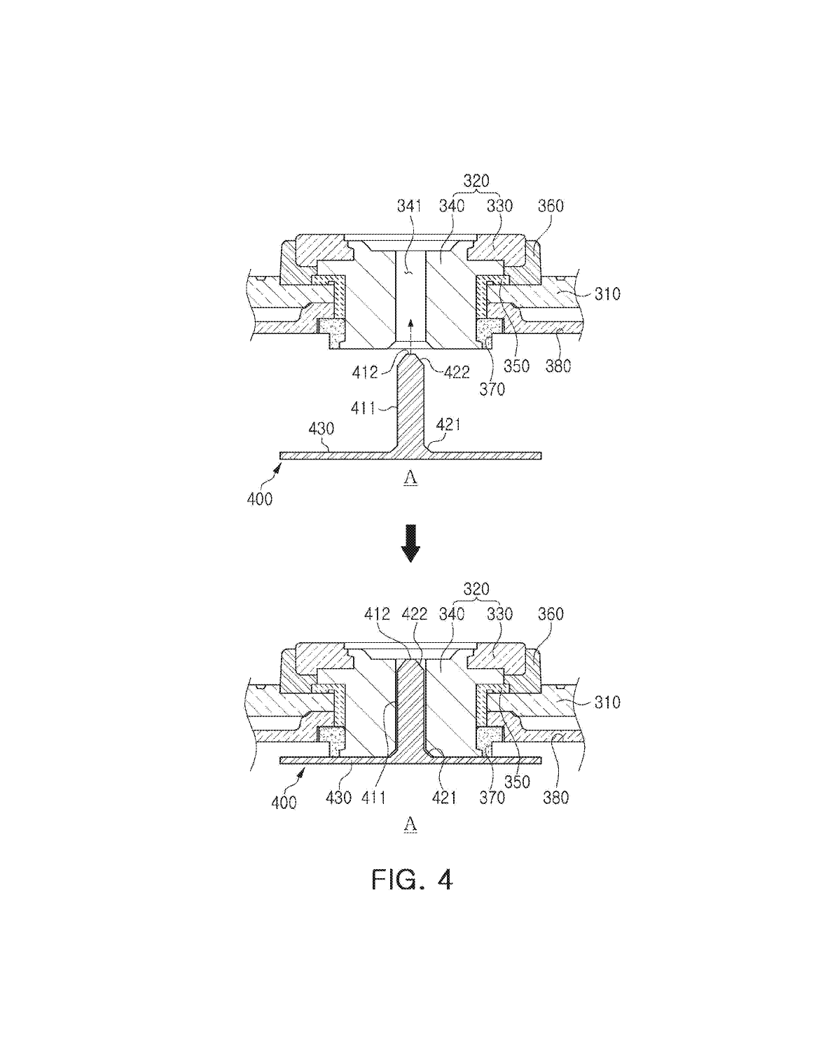

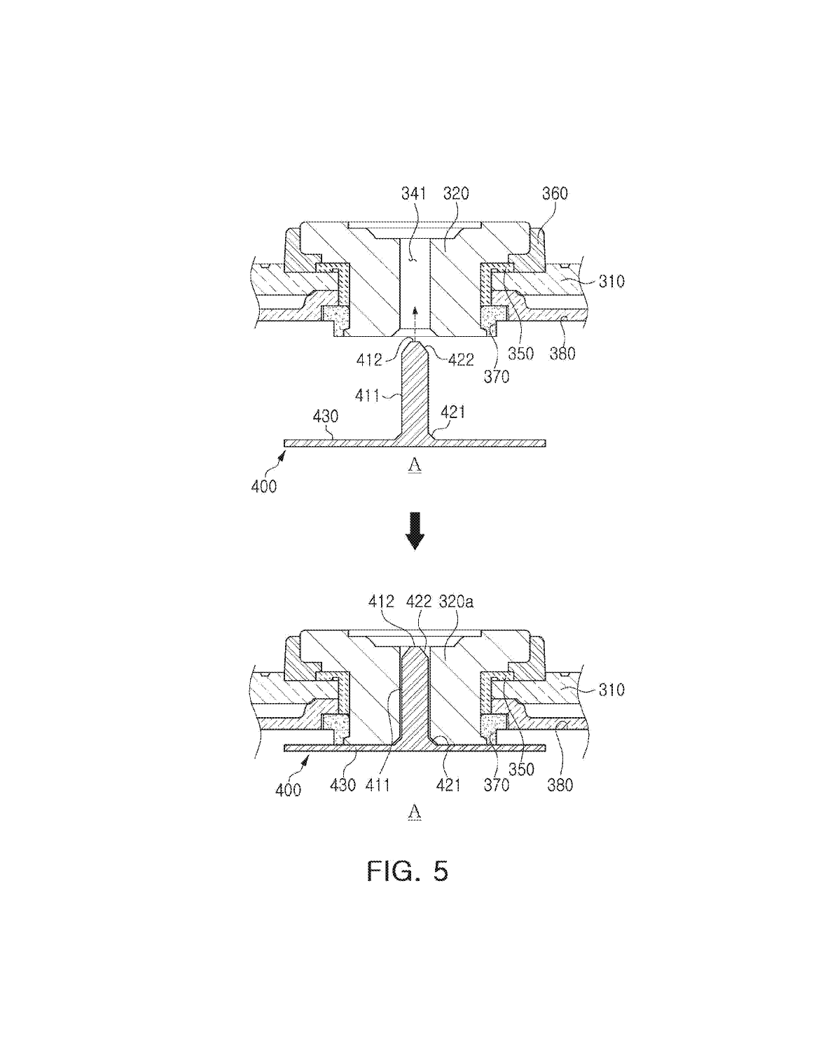

FIG. 4 is a schematic diagram illustrating the assembly process of Part A according to an embodiment, and FIG. 5 is a schematic diagram illustrating the assembly process of Part A according to an embodiment.

With reference to FIGS. 1 to 3, as well as FIGS. 4 and 5, a cap assembly 300 according to an embodiment will be described in more detail.

The cap assembly 300 may include an electrode terminal portion 320 electrically connected to the electrode assembly 200 and a cap plate 310 supporting the electrode terminal portion 320.

Furthermore, the cap assembly 300 may further include a terminal insulator 360 and a gasket 350 that electrically separate the electrode terminal portion 320 and the cap plate 310.

Additionally, the cap assembly 300 may further include a cap insulator 380 that prevents the cap plate 310 from directly shorting the electrode assembly 200.

The electrode terminal portion 320 may include a rivet 340 into which the pin portion 410 is inserted, and a terminal unit 330 coupled to the rivet 340.

The terminal unit 330 may be disposed on the cap plate 310 and serve as a connection terminal that electrically connects the battery cell 10 to an external component (for example, a conductive bus bar).

For this purpose, the terminal unit 330 may be provided as a plate-shaped member formed of a conductive metal, such as aluminum or an aluminum alloy. However, the material of the terminal unit 330 is not limited to aluminum.

The rivet 340 may be coupled to the terminal unit 330.

For example, the rivet 340 may be inserted into the terminal unit 330 and riveted to the terminal unit 330. Furthermore, the rivet 340 and the terminal unit 330 may be coupled to each other by laser welding.

The rivet 340 may include an insertion hole 341 configured to allow the pin portion 410 of the pin assembly 400, described below, to be inserted. The insertion hole 341 may have the shape of a hole penetrating the rivet 340.

The pin portion 410 may be welded to the rivet 340 and electrically connected to the electrode terminal portion 320.

The pin portion 410 of the pin assembly 400, described below, may be inserted and joined to the insertion hole 341 of the rivet 340 and electrically connected to the rivet 340.

Meanwhile, referring to FIG. 5, the electrode terminal portion 320 may be formed integrally. In detail, the terminal unit 330 and the rivet 340 may be formed integrally.

For example, the electrode terminal portion 320 itself may be rivet-coupled to the cap plate.

In this case, providing the electrode terminal portion 320 as an integral part simplifies the configuration of the cap assembly 300, thereby reducing the assembly process time and facilitating manufacturing.

Referring to FIGS. 4 and 5, the cap plate 310 may be configured to couple with the case 100 and support the electrode terminal portion 320.

The cap plate 310 may be configured to close the first opening 130 of the case 100.

For example, the first cap plate 310a is provided as a plate-shaped member and may be joined to the case 100 by laser welding or ultrasonic welding to close the first opening 130.

Meanwhile, if the cap plate 310 includes a conductive material, insulating members formed of an insulating material may be disposed between the electrode terminal portion 320 and the cap plate 310, electrically isolating the electrode terminal portion 320 and the cap plate 310.

For example, the terminal insulator 360 disposed on the rear surface of the terminal unit 330 and the gasket 350 into which the rivet 340 is fitted may be the insulating members.

The terminal insulator 360 includes an insulating material (for example, a polymer) and may be configured to be disposed between the terminal unit 330 and the cap plate 310 to insulate the terminal unit 330 and the cap plate 310 from each other.

The gasket 350 includes an insulating material (for example, a polymer) and may be disposed between the rivet 340 and the cap plate 310 to insulate the rivet 340 and the cap plate 310 from each other.

Meanwhile, the gasket 350 may be disposed to surround the rivet 340, thereby blocking the gap between the rivet 340 and the cap plate 310 and thus preventing foreign substances from outside the battery cell 10 from entering the gap or electrolytes from within the battery cell 10 from leaking through the gap.

An insulating member may be disposed on the rear surface of the cap plate 310 to prevent unintentional short circuiting between the cap plate 310 and components (for example, the electrode assembly 200) housed within the case 100 or the pin assembly 400.

For example, the cap assembly 300 may include a cap insulator 380 that corresponds to an insulating member, covering the rear surface of the cap plate 310. (In this case, the “rear surface of the cap plate 310” may refer to the surface of the cap plate 310 facing the receiving portion 150 of the case 100).

The cap insulator 380 may include an insulating material to prevent the cap plate 310 from contacting the electrode assembly 200 or pin assembly 400 and causing a short circuit.

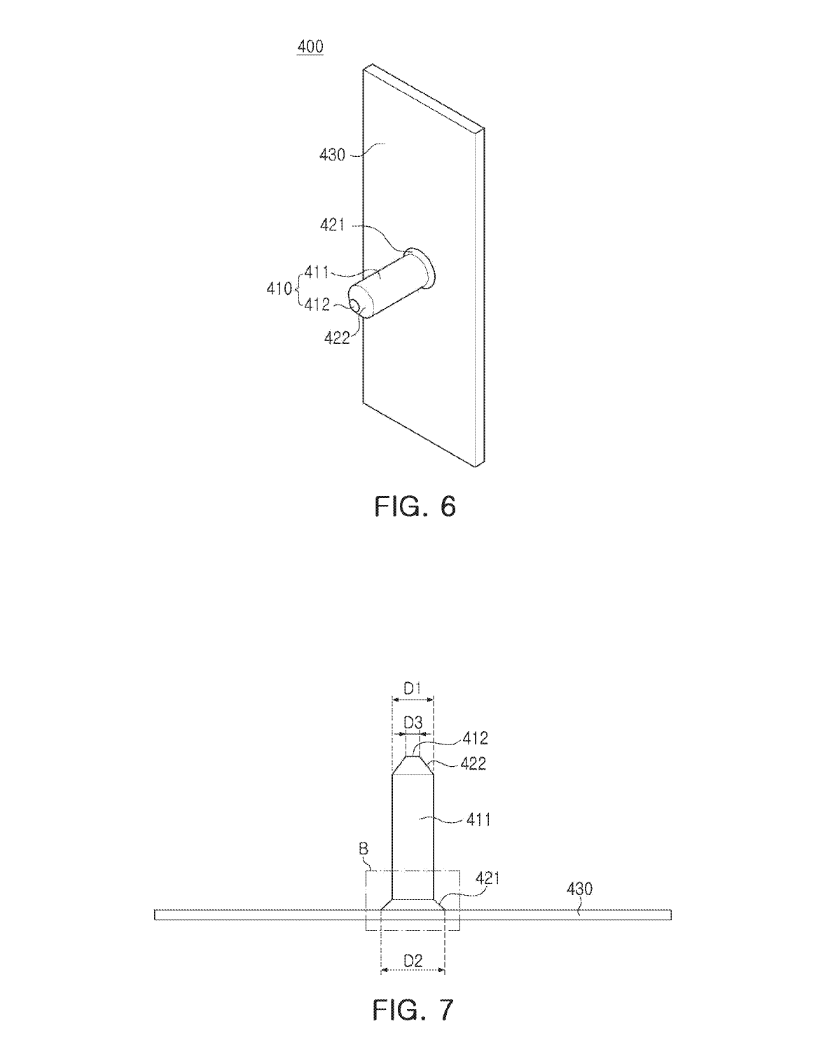

FIG. 6 is a perspective view of a pin assembly according to an embodiment, and FIG. 7 is a side view of a pin assembly according to an embodiment.

Referring to FIGS. 6 and 7, the pin assembly 400 according to an embodiment includes a pin portion 410 electrically connected to the electrode terminal portion 320, and a current collector plate portion 430 electrically connected to the electrode assembly 200. The pin portion 410 and the current collector plate portion 430 may form a first inclined portion 421 and may be formed as a single member.

For example, the pin assembly 400 may be provided with the pin portion 410 and the current collector plate portion 430 as an integral part.

Since the pin assembly 400 according to an embodiment is formed as an integral part, the process of separately manufacturing and assembling the pin portion 410 and the current collector plate portion 430 may be omitted, thereby improving productivity and reducing costs.

In addition, since the pin assembly 400 according to an embodiment is formed as an integral body, the electrical performance may be improved by reducing the resistance generated at the connection portion where the pin portion 410 and the current collector plate portion 430 are assembled by welding or the like.

The pin portion 410 and the current collector plate portion 430 may be formed using a forging process.

For example, rather than coupling the separately formed pin portion 410 and current collector plate portion 430, the pin assembly 400 may be formed as a single, integral part through a forging process.

During the process of forming the pin assembly 400 through a forging process, the pin portion 410 may be formed in a protruding shape, and the plate-shaped current collector plate portion 430 connected to the pin portion 410 may also be formed simultaneously.

In detail, manufacturing the pin assembly 400 through a forging process may improve productivity by eliminating subsequent coupling operations, such as welding or screw fastening.

Furthermore, the pin assembly 400 formed through the forging process has grains aligned in one direction and internal pores reduced, resulting in lower electrical resistance, reduced contact resistance, and resolving potential issues such as increased electrical resistance and structural weakening at the joint.

Hereinafter, a body portion 411, a top portion 412, the first inclined portion 421, and a second inclined portion 422 are described as having a circular cross-section for ease of explanation, but are not limited to this cross-section, and may have various cross-sections, such as quadrangle or ellipse.

The body portion 411 is disposed between the top portion 412 and the current collector plate portion 430, and one end thereof may be connected to the current collector plate portion 430 through the first inclined portion 421, and the other end thereof may be connected to the top portion 412 through the second inclined portion 422.

The first inclined portion 421 may be disposed between the body portion 411 and the current collector plate portion 430, thereby connecting the body portion 411 and the current collector plate portion 430.

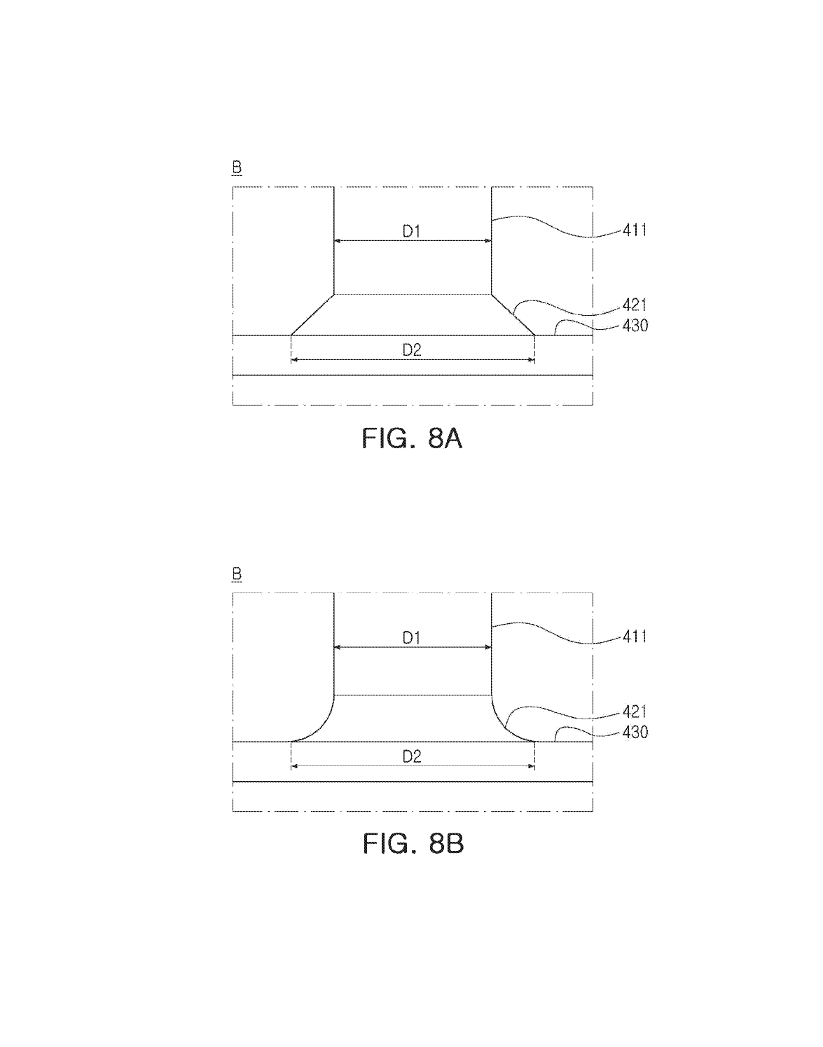

FIGS. 8A and 8B are enlarged views of part B of FIG. 7.

Referring to FIGS. 8A and 8B, the first inclined portion 421 may be disposed between the body portion 411 and the current collector plate portion 430, thereby connecting the body portion 411 and the current collector plate portion 430.

The cross-sectional area of a portion of the first inclined portion 421 connected to the body portion 411 may be different from the cross-sectional area of a portion thereof connected to the current collector plate portion 430.

The cross-sectional area of the connection portion between the body portion 411 and the first inclined portion 421 may be referred to as a first cross-sectional area, and the cross-sectional area of the connection portion between the current collector plate portion 430 and the first inclined portion 421 may be referred to as a second cross-sectional area.

In more detail, the first cross-sectional area formed by the connection portion between the first inclined portion 421 and the pin portion 410 may be smaller than the second cross-sectional area formed by the connection portion between the first inclined portion 421 and the current collector plate portion 430. In detail, the first cross-sectional area may be smaller than the second cross-sectional area.

Similarly, a diameter D1 of the connection portion between the body portion 411 and the first inclined portion 421 may be smaller than a diameter D2 of the connection portion between the current collector plate portion 430 and the first inclined portion 421.

The first inclined portion 421 forms an area in which the second cross-sectional area is larger than the first cross-sectional area, and connects the body portion 411 and the current collector plate portion 430 to each other, so that connection resistance between the body portion 411 and the current collector plate portion 430 may be reduced.

Referring to FIG. 8A, the cross-sectional area of the first inclined portion 421 may decrease from the current collector plate portion 430 toward the body portion 411.

Furthermore, referring to FIG. 8B, a portion of the first inclined portion 421 may vary in cross-sectional area to form a curve, and the first inclined portion 421 may be connected to the body portion 411 or the current collector plate portion 430 by forming a curved surface.

The outer circumferential surface of the first inclined portion 421 may be connected to the outer circumferential surface of the pin portion 410 and the current collector plate portion 430 by forming a curved surface.

In detail, the first inclined portion 421 may be formed such that the portion connected to the body portion 411 is formed continuously in the shape of a curved surface. Additionally, the first inclined portion 421 may be formed to be continuous with a curved surface on the portion of connection with the current collector plate portion 430.

By forming a curved surface on both ends of the first inclined portion 421 and the body portion 411 or the current collector plate portion 430, the current may flow smoothly without abruptly changing direction at the connection portion, thereby reducing current concentration and preventing localized heat generation.

Referring again to FIGS. 6 and 7, the pin portion 410 may include a body portion 411 having one end connected to the current collector plate portion 430 by forming the first inclined portion 421, and an top portion 412 disposed at the other end of the body portion 411. The body portion 411 and the top portion 412 may be connected to form a second inclined portion 422.

The second inclined portion 422 may be disposed between the body portion 411 and the top portion 412, thereby connecting the body portion 411 and the top portion 412.

The second inclined portion 422 may have different cross-sectional areas in a portion thereof connected to the body portion 411 and a portion thereof connected to the top portion 412.

In more detail, a third cross-sectional area formed by the connection portion between the second inclined portion 422 and the body portion 411 may be larger than a fourth cross-sectional area formed by the connection portion between the second inclined portion 422 and the top portion 412.

The cross-sectional area of the portion where the body portion 411 and the second inclined portion 422 are connected may be referred to as the third cross-sectional area, and the cross-sectional area of the portion where the top portion 412 and the second inclined portion 422 are connected may be referred to as the fourth cross-sectional area.

In this case, the body portion 411 may be a configuration extending by forming a cross-sectional area that is approximately the same as a whole, and the first cross-sectional area, which is the cross-sectional area of the portion where the body portion 411 and the first inclined portion 421 are connected, and the third cross-sectional area, which is the cross-sectional area of the portion where the body portion 411 and the second inclined portion 422 are connected, may be approximately the same.

For example, the cross-sectional area of the top portion 412 may be smaller than the cross-sectional area of the body portion 411, and the diameter D1 of the portion where the body portion 411 and the second inclined portion 422 are connected may be larger than the diameter D3 of the portion where the top portion 412 and the second inclined portion 422 are connected.

Referring to FIGS. 4 and 5, along with FIGS. 6 and 7, the pin assembly 400 according to an embodiment is formed such that the cross-sectional area of the top portion 412 is smaller than the cross-sectional area of the body portion 411, thereby facilitating assembly of the pin assembly 400 with the electrode terminal portion 320.

In more detail, the pin portion 410 is provided to form a second inclined portion 422 whose cross-sectional area decreases from the body portion 411 to the top portion 412. Therefore, even if the pin assembly 400 and the insertion hole 341 are slightly misaligned, the top portion 412, which has a relatively smaller cross-sectional area, may be inserted into the insertion hole 341.

Additionally, when the pin portion 410 is continuously inserted into the insertion hole 341 while the top portion 412 is inserted into the insertion hole 341, the second inclined portion 422 may contact the electrode terminal portion 320 and guide the pin portion 410 to be inserted into the insertion hole 341, and the pin assembly 400 and the insertion hole 341 may be naturally aligned and inserted by the second inclined portion 422 and the electrode terminal portion 320.

According to an embodiment, the pin assembly 400 may reduce the connection resistance of the pin assembly 400 by forming the first inclined portion 421 disposed between the body portion 411 of the pin portion 410 and the current collector plate portion 430. In detail, the first inclined portion 421 is formed to form a curved surface and is connected to the pin portion 410 and the current collector plate portion 430, thereby forming a gentle current path and preventing localized heat generation or concentrated current density.

According to an embodiment, the pin assembly 400 forms a second inclined portion 422 disposed between the body portion 411 and the top portion 412 of the pin portion 410, thereby facilitating assembly of the pin assembly 400 and the electrode terminal portion 320.

As set forth above, according to embodiments, a pin assembly and a battery cell including the same may reduce manufacturing processes and manufacturing costs by utilizing an improved pin assembly.

According to embodiments, a pin assembly and a battery cell including the same may facilitate assembly and reduce manufacturing processes, thereby improving productivity.

According to an embodiment, a pin assembly and a battery cell including the same may reduce connection resistance generated in the pin assembly.

Only specific examples of implementations of certain embodiments are described. Variations, improvements and enhancements of the disclosed embodiments and other embodiments may be made based on the disclosure of this patent document.

What is claimed is:

1. A pin assembly comprising:
a pin portion electrically connected to an electrode terminal portion; and
a current collector plate portion electrically connected to an electrode assembly,
wherein the pin portion and the current collector plate portion form a first inclined portion and are formed as a single member.

2. The pin assembly of claim 1, wherein a first cross-sectional area formed by a connection portion between the first inclined portion and the pin portion is smaller than a second cross-sectional area formed by a connection portion between the first inclined portion and the current collector plate portion.

3. The pin assembly of claim 1, wherein an outer circumferential surface of the first inclined portion forms a curved surface along with and is connected to an outer circumferential surface of the pin portion and the current collector plate portion.

4. The pin assembly of claim 1, wherein the pin portion and the current collector plate portion are formed by a forging process.

5. The pin assembly of claim 1, wherein the pin portion includes,
a body portion having one end connected to the current collector plate portion while forming the first inclined portion with the current collector plate portion; and
a top portion disposed at the other end of the body portion,
wherein the body portion and the top portion are connected to form a second inclined portion.

6. The pin assembly of claim 5, wherein a third cross-sectional area formed by a connection portion between the second inclined portion and the body portion is larger than a fourth cross-sectional area formed by a connection portion between the second inclined portion and the top portion.

7. A battery cell comprising:
an electrode assembly;
a case forming a receiving portion for accommodating the electrode assembly;
a cap assembly coupled to the case and having an electrode terminal portion disposed thereon; and
a pin assembly electrically connecting the electrode assembly and the electrode terminal portion,
wherein the pin assembly includes,
a pin portion electrically connected to the electrode terminal portion; and
a current collector plate portion electrically connected to the electrode assembly, and
the pin portion and the current collector plate portion form a first inclined portion and are formed as a single member.

8. The battery cell of claim 7, wherein the pin portion further includes,
a body portion which protrudes and one end of which is connected to the current collector plate portion to form the first inclined portion; and
an top portion disposed at the protruding other end of the body portion,
wherein the body portion and the top portion are connected to form a second inclined portion.

9. The battery cell of claim 7, wherein the electrode terminal portion includes,
a rivet into which the pin portion is inserted; and
a terminal unit coupled to the rivet.

10. The battery cell of claim 9, wherein the pin portion is welded to the rivet and electrically connected to the electrode terminal portion.

11. The battery cell of claim 9, wherein the terminal unit and the rivet are formed integrally.
